(19) United States
(12) Patent Application Publication
(10) Pub. No.: US 2016/0041917 A1
(43) Pub. Date: Feb. 11, 2016

(54) SYSTEM AND METHOD FOR MIRRORING A VOLATILE MEMORY OF A COMPUTER SYSTEM

(71) Applicant: Diablo Technologies, Inc., Ottawa (CA)

(72) Inventors: Bart Trojanowski, Ottawa (CA); Maher Amer, Napean (CA); Riccardo Badalone, St. Lazare (CA); Michael L. Takefman, Napean (CA)

(21) Appl. No.: 14/452,477

(22) Filed: Aug. 5, 2014

(51) Int. Cl. G06F 12/08; G06F 3/06

(52) U.S. Cl. CPC G06F 12/0875; G06F 12/0893; G06F 3/0619; G06F 3/065; G06F 3/0656; G06F 3/0659; G06F 3/068; G06F 2212/1032; G06F 2212/205; G06F 2212/222; G06F 2212/452; G06F 2212/69

(57) ABSTRACT

A system and method for mirroring a volatile memory to a CPIO device of a computer system is disclosed. According to one embodiment, a command buffer and a data buffer are provided to store data and a command for mirroring the data. The command specifies metadata associated with the data. The data is mirrored a non-volatile memory of the CPIO device based on the command.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED FIELD

The present disclosure relates in general to a technique for mirroring a memory update operation in a computer system. The present disclosure further relates a technique for mirroring a volatile memory of a computer system into a co-processor input/output (CPIO) device.

### BACKGROUND

A hybrid memory card refers to a memory card that includes both volatile and non-volatile memories. Both the volatile and non-volatile memories are co-located on the hybrid memory card so that data can be backed up from the volatile memory to the non-volatile memory in an event of a power failure.

A non-volatile memory of a hybrid memory card is useful for data backup but is not generally available as a storage device. For example, a hybrid dual in-line memory module (DIMM) does not maximize the memory capacity of either the volatile memory or the non-volatile memory as a standard volatile memory (e.g., dynamic random access memory (DRAM)) or a standard non-volatile memory (i.e., a solid-state device (SSD)) due to trade-off in areas for each type of the memories.

A memory controller of a central processing unit (CPU) of computer system accesses a main memory system via a memory transaction of a fixed size. The fixed-size memory transaction is limited by two constraints, i.e., the minimum burst size and the CPU cache line size. In modern CPU designs, the minimum burst size and the CPU cache line size have the same value (e.g., 64 Byte). System software may write data in a unit as small as a single bit within a CPU register and/or cache, but must read/write data to main memory in a unit of the cache line.

Mirroring refers to a memory operation of creating a copy of data and placing the copied data to a different memory or device. Typically, different mirroring schemes exist for a main memory, a storage system, and a network system. In the context of a main memory, a memory controller of a CPU automatically handles data mirroring to another memory location. In the context of a co-processor, a mirroring operation provides updated data to the co-processor from the main memory.

The term persistent refers to an ability to retain data across a power failure. If all of the memories in a computer were a hybrid/non-volatile DIMM, every single operation would be a persistent memory operation. If only a portion of the memory is a hybrid/non-volatile DIMM, a memory operation to the volatile DIMM would be lost during a power failure.

### SUMMARY

A system and method for mirroring a volatile memory to a CPIO device of a computer system is disclosed. According to one aspect, a command buffer and a data buffer are provided to store data and a command for mirroring the data. The command specifies metadata associated with the data. The data is mirrored a non-volatile memory of the CPIO device based on the command.

According to another aspect, a computer system includes a central processing unit (CPU), a main memory system comprising a volatile memory, a memory controller configured to control the main memory system, and a CPIO device comprising a buffer and a non-volatile memory. The CPU is configured to run an application and update the volatile memory of the main memory system. The CPIO device is configured to store data and a command in the buffer, the command specifying metadata associated with the data stored in the buffer. The CPIO device is configured to mirror the data to the non-volatile memory based on the command.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate various embodiments and together with the general description given above and the detailed description of the various embodiments given below serve to explain and teach the principles described herein.

FIG. 1 illustrates a block diagram of an exemplary computer system including a CPIO device, according to one embodiment; and

FIG. 2 illustrates a block diagram of an exemplary virtual memory translation system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a system and method of mirroring a volatile memory of a computer system to a co-processor input/output (CPIO) device. The CPIO device may be a non-volatile storage device (NVDIMM), a solid-state device (SSD), a co-processor, a data processing engine, or any other memory or device in the computer system. In particular, NVDIMM is advantageous in implementing the mirroring a volatile memory because it can operate with no changes to a central processing unit (CPU) of a computer system and minor changes to the system software of the computer system.

According to one embodiment, a command buffer and a data buffer are provided to store data and a command for mirroring the data. The command specifies metadata associated with the data. Examples of metadata include, but are not limited to, a size of the data, context, a key, a timestamp. The metadata is stored in the non-volatile memory along with the data. The context is used to allow multiple independent regions to be mirrored. The key is used to address multiple objects within a context (e.g., an offset within a range of memory). The timestamp allows ordering of operations to be maintained when re-constructing the state of the memory. The data and metadata are mirrored to a non-volatile memory of the CPIO device based on the command.

In one embodiment, the metadata is included in the command buffer. In another embodiment, the metadata is included in the data buffer along with the data, and the command stored in the command buffer is merely used to trigger the persistence operation using the data and the metadata stored in the data buffer.

The term “persistence” or “persisting” refers to an act of mirroring data from a volatile memory and storing the mirrored data in a non-volatile memory. The term “persisting” may be used inter-changeably with “mirroring.”

Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general-purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present system and method provides mirroring of a volatile memory of a computer system to a CPIO device. A memory update operation (e.g., a memory write) to a volatile memory is persisted to a non-volatile memory of the CPIO device to back up data, for example, in an event of a power failure. The present disclosure focuses on a device (e.g., a CPIO device, an SSD device) that mirrors data to a non-volatile memory. However, it should be clear that the present mirroring scheme is applicable to other types of data operations and mirroring to other memories, peripherals, or devices, thus the present mirroring scheme not limited to the present persistence technique to a non-volatile memory of a CPIO device.

The present system and method provides mirroring and persistence operations from a volatile memory to a non-volatile memory in a CPIO device. The present system and method also provides an interface between a CPIO device and a memory controller of a computer system to support the mirroring and persistence operations. In one embodiment, the CPIO device maintains a memory-mapped First In First Out (FIFO) buffer. The FIFO buffer is associated to a set of log files to store persistent memory updates in a non-volatile memory. For example, the FIFO buffer includes a data buffer and a command buffer. The CPIO device transfers persistent updates to the non-volatile memory using the data stored in the data buffer according to the commands stored in the command buffer.

In some embodiments, the CPIO device maintains a single context. The single context includes a range of a virtual memory that is being mirrored. In case of a persistence operation, the context includes a range of the non-volatile memory that stores the memory updates. Other CPIO application may require data and control commands that are different from a persistence operation. It is apparent to one of ordinary skill in the art that the present system and method for a persistent operation can be applied to other applications or operations without deviating from the scope of the present disclosure. The CPIO device maintains a set of one or more independent persistence contexts that may be allocated in any possible way. As will be discussed in greater detail below, an application can get a persistence context by making an appropriate function call to the driver of the CPIO device.

According to one embodiment, the CPIO device maintains a data buffer that allows a memory controller to transfer the mirrored data to the CPIO device. In this case, the CPIO device maintains a command buffer for storing commands that direct the CPIO device to operate on the data stored in the data buffer. The data stored in the data buffer is ignored by the CPIO device until the command is received and operated upon. The command structure of the command buffer specifies the size of data in units of bytes in the range of 1 byte to the size of a data buffer. The size of the data may be in an arbitrary unit (e.g., cache line size), and the CPIO device and the CPU coordinate to determine the size of the data for mirroring as specified by the command. The command structure of the command buffer may link multiple data buffers together to create a larger single data buffer. The command may include a persistence context or a flash Logical Block Address (LBA).

According to one embodiment, the CPIO device is pre-configured to associate a context to a data buffer. The data and metadata for each operation are written into the CPIO data buffer, and the command buffer is used to trigger the persistence operation. This embodiment supports persistence of the context in an event of a system power failure. When a system power fail occurs, and the CPU can no longer write to the CPIO, the CPIO can continue to copy the contents of its buffers to the pre-configured persistence context. The CPIO receives an interrupt that indicates a loss of power and persists the information in the data buffer to the non-volatile memory. The metadata stored in the data buffer provides information to allow a reconstruction operation to determine if the last data written is a duplicate, or incomplete.

In some embodiments, the data buffer is a FIFO buffer. Data and metadata may be automatically transferred to the CPIO device for persistence operation without a need of sending an explicit command. The mapping of the data buffer to a particular persistence context may be done during a set-up phase. Two or more buffers may map to the same context to achieve a higher throughput through the double-buffering technique.

According to another aspect, a data buffer includes both data and metadata. The metadata includes the persistence context or LBA information. In this case, mirroring is less efficient due to the presence of the metadata but more flexible as a single FIFO can service multiple persistence contexts. It is apparent to an ordinary skilled person in the art that various numbers and/or sizes of data buffer and distinct contexts may be used without deviating from the scope of the present disclosure.

Referring now to still another aspect, the present system and method mirrors a cache line update to a volatile memory to a CPIO device prior to a main memory update. Various components of the computer system may participate in providing a persistence operation to a CPIO device. In one embodiment, a CPU of the computer system explicitly performs the mirroring function to a CPIO, and the CPIO performs the persistence operation. A set of library functions is provided to allow an application to selectively persist data. In another embodiment, a virtual memory management subsystem of a CPU is used to trap a write operation to a volatile memory, and an operating system (OS) driver is used to perform the persistence function. In yet another embodiment, the operating system or a hypervisor uses a memory management trap to trigger an emulation of the instruction and perform the mirroring. In still another embodiment, the present system and method uses a modified compiler to generate a code and mirror data that is tagged as requiring mirroring or persistence. In another embodiment, an object oriented language has its base classes extended to include a persistent operation. In yet another embodiment, a run-time environment (e.g., Java Virtual Machine) automatically generates a persistence operation for an appropriate data.

According to yet another aspect, CPU instruction set and the memory controller provides a fence instruction that guarantees that a previous outstanding write operation is committed to the CPIO memory once the instruction is complete. Some processors have fence instructions that guarantee data is delivered to the memory controller and not to the actual memory. The fence instruction may be used to complete a persistence operation prior to the executing of a main memory update to ensure that the data is safely persisted to a non-volatile memory. Without a fence instruction, a memory update may be lost in an event of a power failure as the outstanding persistence operation may still be pending even the main memory update is completed. According to yet another aspect, a cache-flush instruction is used to ensure that the data has been copied to the CPIO memory once the instruction is complete.

Referring now to another embodiment, the CPIO device provides address aliasing. The same location in the CPIO device can be read from at least two different host addresses. In this case, the equivalent of the fence instruction is constructed by a loop where the data is written to the first alias and a read back from the second alias is compared. When the data has been accepted by the CPIO device, the comparison is successful. The metadata includes a field that acts as a sequence number, insuring that back-to-back writes of the same data is not identical. It is apparent to one of ordinary skill in the art that the loop could be implemented in either a hardware state machine of a software state machine.

According to one embodiment, the CPIO device polls the status of the command buffer and executes a persistence operation. The status polling for mirroring data by the CPIO device may be a fence instruction that the CPU or the complier enforces to impose an ordering constraint to the memory update operations by the main memory controller. In response to a cache line update, the CPIO device may be required to complete a persistence operation to a non-volatile memory prior to a main memory update and report to the memory controller such that the memory controller can proceed with the main memory update. In one embodiment, the present system and method provides a new set of fence instructions to implement the mirroring and persistence operations between the CPIO device and the memory controller. In another embodiment, the CPIO device implements a set operations equivalent to a fence instruction and coordinates with the memory controller to enforce the ordering constraint on memory operations.

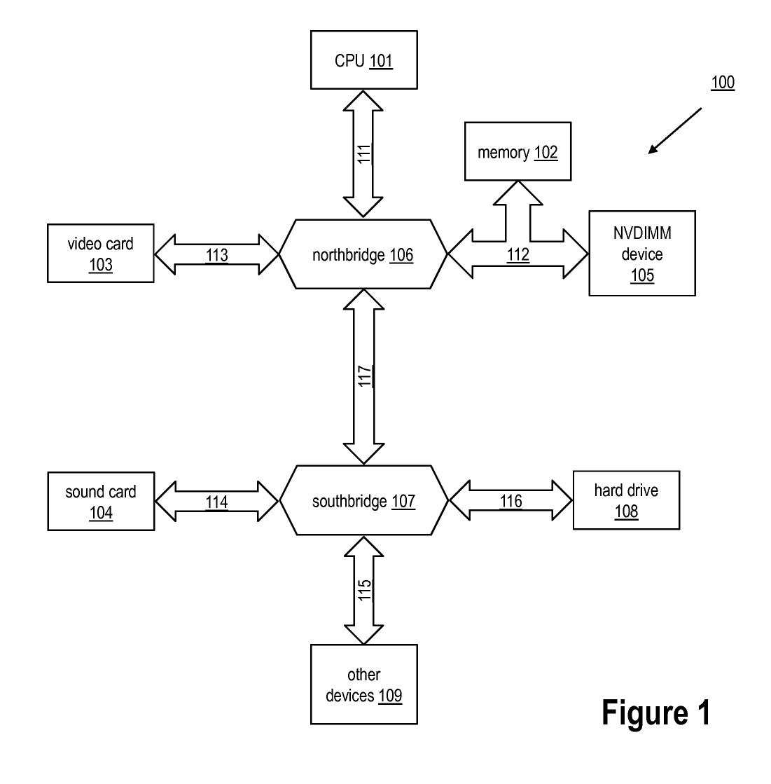

FIG. 1 illustrates a block diagram of an exemplary computer system including a CPIO device, according to one embodiment. A computer system 100 includes a central processing unit (CPU) 101, a main memory unit (e.g., dynamic random access memory (DRAM)) 102, and CPIO devices including a video card 103, a sound card 104, a hard drive 108, and any generic CPIO device 105. These components are connected together via buses on a motherboard (not shown). The CPU 101, the main memory unit 102, and the video card 103 are connected to a northbridge 106 via a front-side bus (FSB) 111, a main memory bus 112, and a peripheral component interconnect express (PCIe) bus 113, respectively. The northbridge 106 generally refers to a chip in a chipset of the motherboard that connects a high-speed bus.

Slower buses, including the PCI bus 114, a universal serial bus (USB) 115, and a serial advanced technology attachment (SATA) bus 116 are usually connected to a southbridge 107. The southbridge 107 generally refers to another chip in the chipset that is connected to the northbridge 106 via a direct media interface (DMI) bus 117. The southbridge 107 manages the information traffic between CPIO devices that are connected via a low-speed bus. For example, the sound card 104 typically connects to the computer system 100 via the PCI bus 114. Storage drives, such as the hard drive 108, typically connect to the computer system 100 via the SATA bus 116. A variety of other devices 109, ranging from a keyboard to an mp3 music player, may connect to the system 100 via the USB 115.

Similar to the main memory unit 102 (e.g., DRAM), the generic CPIO device 105 connects to a memory controller in the northbridge 106 via the main memory bus 112. For example, the generic CPIO device 105 may be inserted into a dual in-line memory module (DIMM) memory slot. Because the main memory bus 112 generally supports higher bandwidths (e.g., compared to the SATA bus 116), the exemplary computer system of FIG. 1 connecting the generic CPIO device 105 to the main memory bus eliminates or alleviates I/O bottlenecks that would otherwise limit the I/O performance of the generic CPIO device 105.

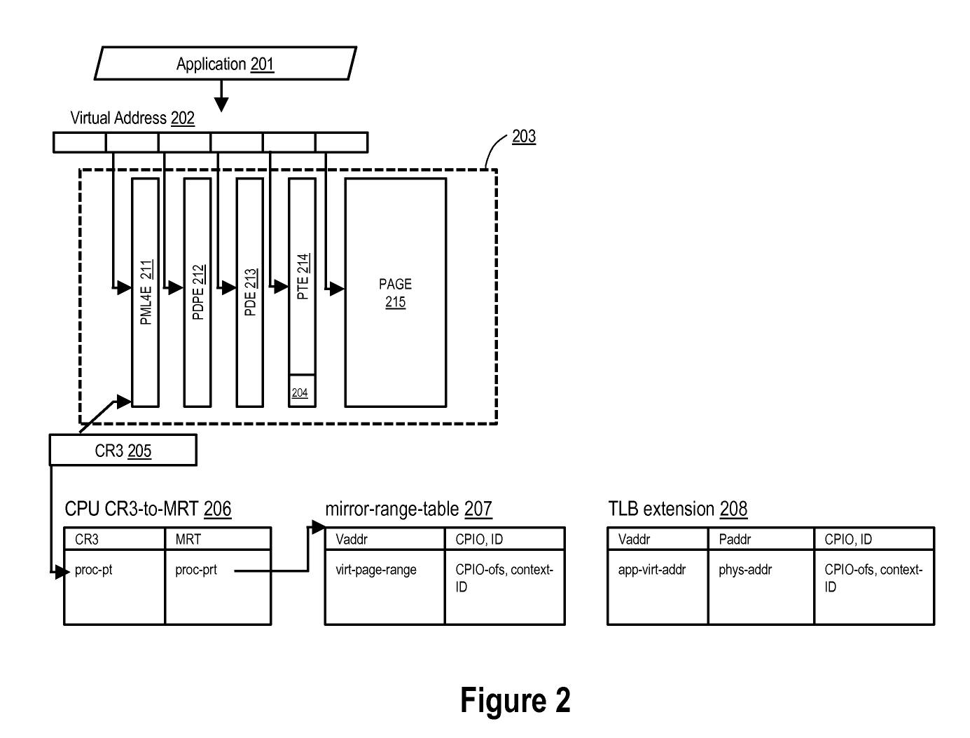

FIG. 2 illustrates a block diagram of an exemplary virtual memory translation system, according to one embodiment. Application 201 generates a virtual address reference 202. The virtual address reference 202 is translated to page tables via a virtual-to-physical mapping structure 203. The virtual-to-physical mapping structure 203 includes a page map level for entry (PML4E) 211, a page directory pointer entry (PDPE) 212, a page directory entry (PDE) 213, a page table entry (PTE) 214, and a translation page 215. The page table entry (PTE) 214 includes a mirror bit 204 that indicates to the CPU (and/or the memory controller) that data should be mirrored. The PML4E 211 includes a control register 3 (CR3) pointer 205 that is unique per process and points to translation tables including a top level table 206, a mirror-range-table (MRT) 207, and a translation look-aside buffer (TLB) 208. An entry in the top level table 206 points to the MRT 207. The mirror-range-table table 207 contains multiple entries that describe a virtual memory range, a paired CPIO address offsets and context ID. The TLB 208 is augmented to contain the critical information from the MRT 207.

According to one embodiment, the TLB 208 and page table entry 214 includes a context that directs a location for data mirroring. The context includes a pointer to the CPIO buffer and information on populating the data buffer and metadata, if necessary. The fields in the page table can be set based on an application 201 that requests the page be mirrored or based on a policy decision of the operating system. Once the mirror bit 204 is set, the CPU causes any writes to that page to first be written to the CPIO device (with appropriate fencing operations) and then to a volatile memory.

The CPU (and/or the memory controller) is unaware or incapable of automatically mirroring memory. In this case, the present system and method provides a set of library functions to rewrite an application to explicitly mirror a selected portion of or the entire volatile memory. Examples of such library functions include, but are not limited to, functions to 1) create a new persistence context for an application, 2) manage an existing persistence context including recreating the memory image after a system failure, 3) reset a persistence context, 4) delete a persistence context, and 5) update the persistence context with volatile memory data. It would be apparent to one of ordinary skill in the art when and how the application would call the library functions.

In one embodiment, the present system and method uses a CPU memory management unit to cause exceptions (or traps). The CPU memory management unit causes exceptions when a write operation to a mirrored page is attempted by using an existing protection mechanism (e.g., write-protection) of the page tables and substituting an exception handler. In some embodiments, the exception handler analyzes an operation that causes an exception, creates and calls the library functions to update the persistence context. It is apparent to one of ordinary skill in the art that calling library functions by an exception handler is applicable to an operating system (e.g., Linux) or a hypervisor (e.g., ESX).

According to one embodiment, the present system and method modifies a compiler to generate a code for persistence operations. Store instructions (i.e., writes) to variables are marked as requiring persistence. A modifier for a variable type declaration indicates a persistence request. The compiler and a linker place persistent variables into the virtual pages. The compiler may be modified in various ways. For example, a new persistent memory allocator function is created (e.g., persistent_malloc) and is used to create variables that are persistent. In another example, a new pointer type is created (e.g., persistent void *pointer_variable) that causes an additional operation required to mirror the data to the CPIO and to the volatile memory.

In one embodiment, the present system and method uses an object oriented programming language to implement persistence operations. A persistent base-class is declared where an update to the persistent data that belongs to the class instance causes a persistent library function to execute. It is apparent to one of ordinary skill in the art that other programming languages may be used to implement persistence operations.

In some embodiments, the present system and method provides a run-time environment for an interpreted or modified Just-In-Time complied language. Update to an object/data that is marked for persistence causes the virtual machine (VM) that is executing the application to execute an appropriate library function to execute when the object and data are updated.

The above example embodiments have been described hereinabove to illustrate various embodiments of implementing a system and method for mirroring volatile memory updates in a computer system. Various modifications and departures from the disclosed example embodiments will occur to those having ordinary skill in the art. The subject matter that is intended to be within the scope of the present disclosure is set forth in the following claims.

We claim:

1. A method for mirroring a volatile memory of a computer system to a co-processor input/output (CPIO) device, the method comprising:
providing a command buffer and a data buffer;
receiving a command and data, the command specifying metadata associated with the data;
storing the command in the command buffer and storing the data in the data buffer; and
mirroring the data and the metadata to a non-volatile memory of the CPIO device based on the command.

2. The method of claim 1, further comprising storing the metadata in the command buffer.

3. The method of claim 1, further comprising storing the metadata in the data buffer.

4. The method of claim 1, wherein the metadata comprises one or more of a size of the data, context, a key, and a timestamp associated with the data.

5. The method of claim 1, wherein the CPIO device comprises the command buffer and the data buffer.

6. The method of claim 1, wherein the size of the data is a variable size.

7. The method of claim 6, wherein the variable size is a cache line size.

8. The method of claim 1, wherein the command buffer and the data buffer are mixed in a First In First Out (FIFO) buffer.

9. The method of claim 1, further comprising providing a plurality of functions to:
create a persistence context for an application running on the computer system;
manage the persistence context including recreating a memory image;
reset the persistence context;
delete the persistence context; and
update the persistence context with data stored in the volatile memory.

10. The method of claim 9, further comprising: providing a run-time environment in which an object or data that are marked for persistence causes a function of the plurality of functions to execute when the object and data is updated.

11. The method of claim 9, wherein an instruction for mirroring the data and the metadata is synchronized with a fence instruction or a cache flush instruction.

12. The method of claim 6, further comprising:
analyzing a memory write operation; and
handling an exception to a mirrored page.

13. The method of claim 1, further comprising: provides address aliasing, wherein a memory location in the CPIO is read from at least two different host addresses, and wherein the data is written to the first alias and a read-back from the second alias is compared with the data written to the first alias.

14. The method of claim 1, further comprising:
generating a virtual address reference;
providing a virtual-to-physical mapping table comprising a page table entry, the page table entry comprising a mirror bit that indicates the data to be mirrored to a physical address as specified in a translation look-aside buffer (TLB); and
mapping the virtual address reference to the physical address.

15. The method of claim 1, wherein an instruction for mirroring the data and metadata is performed by a memory controller or a central processing unit (CPU) of the computer system.

16. The method of claim 1, wherein an instruction for mirroring the data and metadata is performed by the CPIO device.

17. A computer system comprising:
a central processing unit (CPU);
a main memory system comprising a volatile memory;
a memory controller configured to control the main memory system; and
a CPIO device comprising a buffer and a non-volatile memory,
wherein the CPU is configured to run an application and update the volatile memory of the main memory system,
wherein the CPIO device is configured to store a command and data in the buffer, the command specifying metadata associated with the data stored in the buffer, and
wherein the CPIO device is configured to mirror the data and metadata to the non-volatile memory based on the command.

18. The computer system of claim 17, wherein the metadata comprises one or more of a size of the data, context, a key, and a timestamp associated with the data.

19. The computer system of claim 17, wherein the buffer comprises a command buffer and a data buffer and wherein the data is stored in the data buffer and the command is stored in the command buffer.

20. The computer system of claim 19, wherein the metadata is stored in the command buffer.

21. The computer system of claim 19, wherein the metadata is stored in the data buffer.

22. The computer system of claim 17, wherein the command buffer and the data buffer are mixed in a First In First Out (FIFO) buffer.

23. The computer system of claim 17, wherein an instruction for mirroring the data and metadata to the non-volatile memory of the CPIO device is synchronized with a fence instruction or a cache flush instruction.

24. The computer system of claim 17, wherein the application generates a virtual address reference and a virtual-to-physical mapping table comprising a page table entry, the page table entry comprising a mirror bit that indicates the data to be mirrored to a physical address and the CPIO device mirrors the data to the physical address.

25. The computer system of claim 24, wherein the physical address is specified in a translation look-aside buffer (TLB).

26. A device comprising:
a memory interface to a memory controller that is configured to control a main memory system of a computer system;
a mirroring buffer; and
a non-volatile memory,
wherein the device is configured to:
receive data and a command from the memory controller via the memory interface, the command specifying metadata associated with the data stored in the buffer;
store the data and the command in the mirroring buffer; and
mirror the data and the metadata to the non-volatile memory based on the command.

27. The device of claim 26, wherein the metadata comprises one or more of a size of the data, context, a key, and a timestamp associated with the data.

28. The device of claim 26, wherein the mirroring buffer comprises a command buffer and a data buffer and wherein the data is stored in the data buffer and the command is stored in the command buffer.

29. The device of claim 28, wherein the metadata is stored in the command buffer.

30. The device of claim 28, wherein the metadata is stored in the data buffer.

31. The device of claim 26, wherein an instruction for mirroring the data and the metadata to the non-volatile memory of the device is synchronized with a fence instruction or a cache flush instruction.
